(19) United States
(12) Patent Application Publication
(10) Pub. No.: US 2022/0127876 A1
(43) Pub. Date: Apr. 28, 2022

(54) Interior Handle for Upward Acting Vehicle Door

(71) Applicant: Overhead Door Corporation, Lewisville, TX (US)

(72) Inventor: Matthew R. Yost, Marion, OH (US)

(73) Assignee: Overhead Door Corporation

(21) Appl. No.: 17/077,864

(22) Filed: Oct. 22, 2020

(51) Int. Cl. E05B 3/00; B62D 65/06; E05B 1/00

(52) U.S. Cl. CPC E05B 3/00; E05B 1/003; B62D 65/06

(57) ABSTRACT

A door operating system includes: a handle having: loop shaped gripping portion; an attaching portion defining a slot; structure enclosing the slot, the structure defining fastener holes, wherein the slot is defined by the attaching portion and the structure enclosing the slot; and a door operating lever located in the slot. A method of making a door operating system includes: forming a handle having loop shaped gripping portion and an attaching portion; forming a slot in an attaching portion; enclosing the slot with a structure, the structure defining fastener holes, defining the slot with the attaching portion and the structure enclosing the slot; locating a door operating lever in the slot; and attaching the handle to the operating lever with fasteners located in the fastener holes.

### TECHNICAL FIELD

This patent disclosure relates generally to a door handle and, more particularly, to a door handle system for an upward acting vehicle cargo door.

### BACKGROUND

Cargo vehicles such as trailers or trucks sometimes use upward acting doors. These doors may be equipped with both interior and exterior door handles to unlatch/unlock the doors and provide something for the operators to hold on to for operation of the door.

Improvements in operation and/or ergonomics of the door handles is always welcome.

### SUMMARY

The foregoing needs are met to a great extent by embodiments in accordance with the present disclosure, wherein, some embodiments allow for a handle system with both an exterior and interior door handle.

In one aspect, the disclosure describes a door operating system. The system includes: a handle having: loop shaped gripping portion; an attaching portion defining a slot; structure enclosing the slot, the structure defining fastener holes, wherein the slot is defined by the attaching portion and the structure enclosing the slot; a door operating lever located in the slot.

In another aspect, the disclosure describes a method of making a door operating system. The method includes: forming a handle having loop shaped gripping portion and an attaching portion; forming a slot in an attaching portion; enclosing the slot with a structure, the structure defining fastener holes, defining the slot with the attaching portion and the structure enclosing the slot; locating a door operating lever in the slot; and attaching the handle to the operating lever with fasteners located in the fastener holes.

In yet another aspect, the disclosure describes a door operating system. The system includes: a handle having: loop shaped gripping portion; an attaching portion defining a slot; structure enclosing the slot, the structure defining fastener holes, wherein the slot is defined by the attaching portion and the structure enclosing the slot; a door operating lever located in the slot.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is a perspective view of a door handle system in accordance with the present disclosure.

FIG. 2 is an exploded, perspective view of a door handle system in accordance with the present disclosure.

FIG. 3 is a front view of a door handle system in accordance with the present disclosure.

FIG. 4 is a top view of a door handle in accordance with the present disclosure.

FIG. 5 is a perspective view of a door handle in accordance with the present disclosure.

FIG. 6 is a front view of a door handle in accordance with the present disclosure.

FIG. 7 is a right side view of a door handle in accordance with the present disclosure.

### DETAILED DESCRIPTION

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

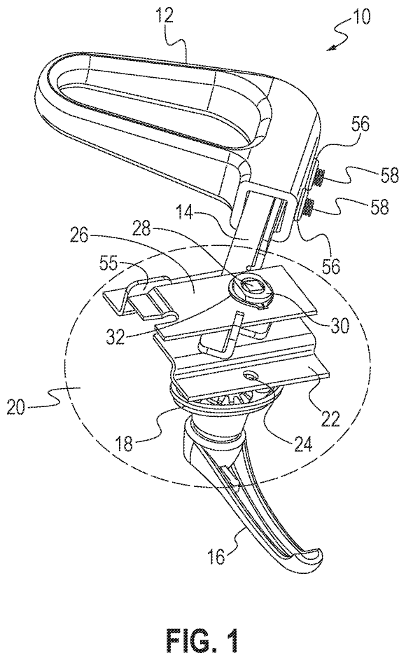

FIG. 1 shows a handle system 10. The handle system may be used for a variety of purposes including as a handle system 10 for an upward acting door in a vehicle. The handle system 10 includes a handle 12 which is loop shaped, or defines a loop in the embodiment shown in FIGS. 1-7.

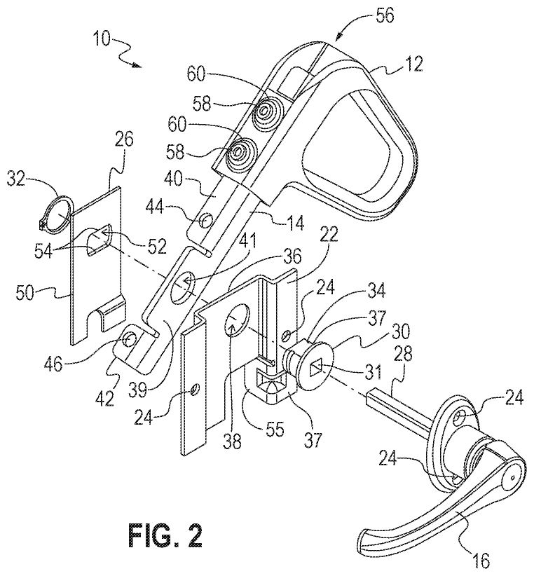

FIGS. 1 and 2 show the handle system 10 assembled in FIG. 1 and an exploded view in FIG. 2. The handle system system 10 has a handle 12 attached to an actuating bar 14. The actuating bar 14 has various cross-sections along its length. The actuating bar 14 has a generally L shaped cross-section but at some lengths it has an I, l or 1 (without the serifs) shaped cross-section. The handle 12 is an interior handle found on the interior side of a door. The interior handle 12 is connected via the actuating bar 14 to an exterior handle 16. The exterior handle 16 is attached via an attaching plate 18 to a door 20 (shown in phantom lines in FIG. 1) actuation of either handle 12 or 16 may operate the handle system 10.

The handle assembly 10 includes an interior mounting plate 22 which includes mounting holes 24 for attaching the interior mounting plate 22 to the door 20. A rotating plate 26 is located on the opposite side of the actuating bar 14 then the interior mounting plate 22. A shaft 28 extends from the exterior handle 16. In the FIGS., the shaft 28 is shown to have a square cross-section, but in other embodiments, other shaped shafts 28 may be used. A mounting fastener 30 has a hole 31 corresponding to the shape of the shaft 28 to allow the mounting fastener 30 to slide along the shaft 28 and also rotate when the shaft 28 rotates.

A snap ring 32 is dimensioned to reside in a groove 34 in the mounting fastener 30. In some embodiments, the mounting fastener 30 has two flat sections 36 and two rounded sections 37. As shown, the groove 34 is only in the rounded sections 37, but in other embodiments, there may be a groove 34 in the flat sections 36 and rounded sections 37. In still other embodiments, the mounting fastener 30 may not have flat sections 36, but have some other shape.

A through hole 38 that is dimensioned to allow at least a portion of the mounting fastener 30 to pass through the hole 38 is located in the flat portion 36 in the interior mounting plate 22. The interior mounting plate 22 has a flat portion 36 that can lay flat against a flat portion 39 of the actuation bar 14. An attaching hole 41 is located in the flat portion 39 of the actuation bar 14.

The actuation bar 14, as mentioned above, may have a generally L shaped cross-section but at some lengths it has an I, l or 1 (without the serifs) shaped cross-section. Where the actuation bar 14 has an L shaped cross section, the actuation bar 14 has a first folded over section 40 and a second folded over section 42. The folded over portions 40 and 42 are at right angles from flat portion 39 which is not folded over and has an I (without serifs) shaped cross section. While the term “folded over portion” is used, it should be understood that in other embodiments, the actuation bar 14 may be formed by other means than folding. It could be extruded, comprised of various joined together sections or any other suitable method.

The folded over portions 40 and 42 contain holes 44 and 46 which are cable eyes for attaching cables (not shown) for actuating latches (not shown) to unlatch the door 20 to allow it to move. The operation of the cables to actuate the door 20 and attaching the cables to a handle system is conventional, and known in the art, and will not be explained in detail as it is not relevant to what is claimed. An example of how cables may attach to a handle system and be used to operate a latch system for a door is explained in U.S. Pat. No. 10,526,820 which is incorporated herein by reference in its entirety for reference.

The rotating plate 26 has a flat portion 50. The flat portion 50 has a fastener hole 54 that is shaped to correspond to the shape of the mounting fastener 30 so that when the mounting fastener 30 rotates, the rotating plate 26 will rotate. In the embodiment shown, the fastener hole 52 has flat sides 54 that correspond with the shape of the mounting fastener 30. The rotating plate 26 may be limited in its rotation by a projection 55 on the interior mounting plate 22. The second folded over area 42 may also contact the rotating plate 26 to move, be moved by, or limit movement of the rotating plate 26 when the actuating bar 14 is in certain orientations.

The use of a snap ring 32 on the mounting fastener 30 may provide some advantages over other types of fastening systems. For example, a snap ring 32 and groove 34 on the mounting fastener 30 are advantageous over threads on a nut and threaded mounting fastener because a threaded nut and threaded fastener may loosen or move along the length of the threaded fastener over time. Further, care may need to be taken of how much to tighten a threaded nut on a threaded fastener in order to place the threaded nut at a desired location along the threads of the threaded fastener or at a desired torque level. Such issues are obviated by using a snap ring and groove on the mounting fastener 30.

The handle 12 has a slot 56 for receiving the actuating bar 14. The actuating bar 14 is attached to the handle 12 with fasteners 58. The bosses 60 in the handle 12 and provide reinforcement for the holes in which the fasteners 58 reside.

As shown in FIG. 2, interior mounting plate 22, the flat portion 39 of the actuating bar 14 and the rotating plate 26 all have substantially flat portions that contact each other when the handle system 10 is assembled with the mounting fastener 30. The flat geometry of these parts, 22, 39 and 26 reduce the likelihood of the parts 22, 39, and 26 from moving and rocking with respect to each other then designs were the parts 22, 39, and 26 do not all have substantially flat contact surfaces. The reduced likelihood of moving and rocking with respect to each other reduces play in the handle system 10 and adds to the robustness and desirability of the design.

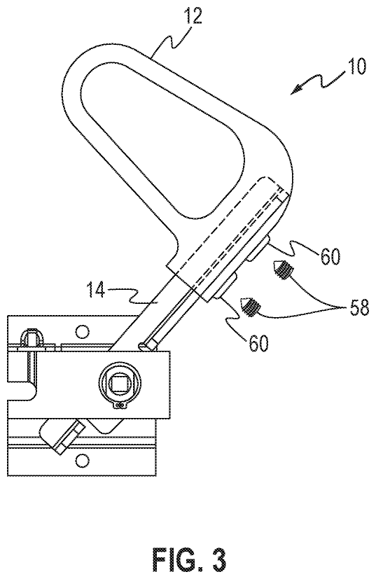

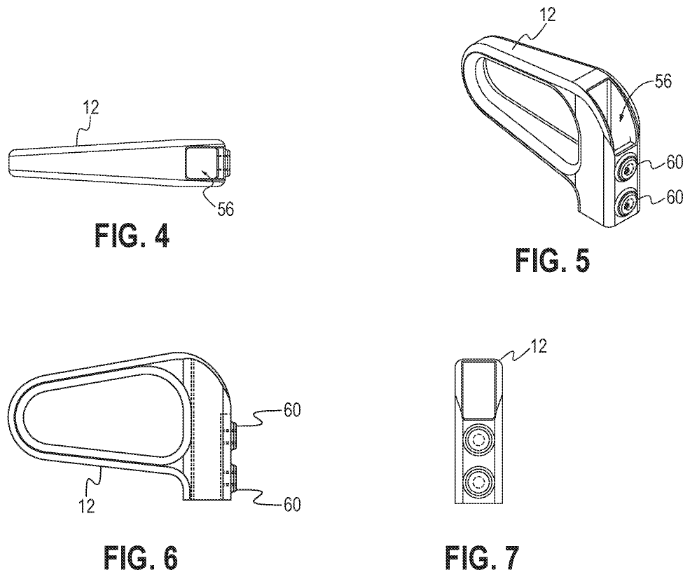

FIG. 3 is a front view of a handle system 10 showing the handle 12, bosses 60 and the fasteners 58 aligned with the bosses 60 to secure the actuating bar 14 to the handle 12. FIGS. 4-7 are top, isometric, front and right side views of the handle 12 showing the slot 56 and bosses 60.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

I claim:

1. A door operating system comprising:
a handle having:
loop shaped gripping portion;
an attaching portion defining a slot; and
structure enclosing the slot, the structure defining fastener holes,
wherein the slot is defined by the attaching portion and the structure enclosing the slot; and
a door operating lever located in the slot.

2. The door operating system of claim 1, wherein the door operation lever has an L cross-section.

3. The door operating system of claim 2, wherein a portion of the door operation lever has an I shaped cross-section.

4. The door operating system of claim 3, wherein the portion with the I shaped cross-section defines an attaching hole.

5. The door operating system of claim 4, further comprising:
an attaching bolt dimensioned to reside in the attaching hole;
a groove in the attaching bolt; and
a snap ring dimensioned to reside in the groove to retain the attaching bolt in the attaching hole.

6. The door operating system of claim 4, wherein the operation lever defines at least two cable holes for attaching cables.

7. The door operation system of claim 4, further comprising an attaching plate and retaining plate each having flat sides to lay flat against the portion with the I shaped cross-section, wherein the flat sides of the attaching plate and retaining plate have attaching holes located to align with the attaching hole in the portion with the I shaped cross-section and dimensioned to allow the attaching bolt to reside in the attaching holes.

8. The door operating system of claim 1, where the handle defines fastening holes for fasteners to attach the handle to the door operating lever located in the slot.

9. The door operating system of claim 8, further comprising bosses on the handle that define the fastening holes.

10. The door operating system of claim 1, wherein the loop of the loop shaped gripping portion is wider proximate to the slot then distal to the slot.

11. A method of making a door operating system comprising:
forming a handle having loop shaped gripping portion and an attaching portion;
forming a slot in an attaching portion;
enclosing the slot with a structure, the structure defining fastener holes,
defining the slot with the attaching portion and the structure enclosing the slot;
locating a door operating lever in the slot; and
attaching the handle to the door operating lever with fasteners located in the fastener holes.

12. The method of claim 11, further comprising attaching the handle to a second handle with a mounting fastener and a snap ring, the snap ring being located in a groove in the mounting fastener.

13. The method of claim 11, wherein a portion of the operating lever has an L shaped cross-section and a portion of the operating lever has an I shaped cross-section.

14. The method of claim 13, comprising locating a flat surface of the handle to a flat surface of a handle mounting plate and a flat surface of an attaching plate.

15. A door operating system comprising:
a handle having:
loop shaped gripping portion;
an attaching portion defining a slot; and
structure enclosing the slot, the structure defining fastener holes,
wherein the slot is defined by the attaching portion and the structure enclosing the slot;
a door operating lever located in the slot.

16. The door operating system of claim 15, further comprising a first surface defining the slot engaged with a first surface of the door operating lever and a second surface defining the slot engaged with a second surface of the door operating lever, wherein the door operating lever has an L shaped cross-section and the first and the second surfaces of the door operating lever are at right angles with respect to each other.

17. The door operating system of claim 16, further comprising a first hole in the first surface of the door operating lever and a second hole in the second surface of the door operating lever.

18. The door operating system of claim 15, wherein the door operating lever is attached to a fastener attached to a snap ring.

19. The door operating system of claim 15, further comprising fasteners attached into the fastener holes and holes in the handle to secure the handle to the door operating lever.

20. The door operating system of claim 15, further comprising bosses located around the fastener holes on the handle.
